(19) United States
(12) Patent Application Publication
(10) Pub. No.: US 2010/0023334 A1
(43) Pub. Date: Jan. 28, 2010

(54) AUDIO CODING APPARATUS, AUDIO CODING METHOD AND RECORDING MEDIUM

(75) Inventor: Nobuhide EGUCHI, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/505,533

(22) Filed: Jul. 20, 2009

(30) Foreign Application Priority Data
Jul. 28, 2008 (JP) 2008-193957

(51) Int. Cl. G10L 19/00

(52) U.S. Cl. 704/500; 704/E21.001

(57) ABSTRACT

An audio encoding apparatus includes: a sub-band division part dividing a quantized value into sub-bands; an integrated codeword length table including a plurality of codeword length tables storing codeword lengths of individual code books and a plurality of codeword length tables; a code book selection part selecting, from the plurality of code books, the given combination of code books; a codeword length table selection part selecting a codeword length table; an index value calculation part sequentially calculating an index value to be used by the code book; a codeword length calculation part collectively obtaining codeword lengths for each code book; and a coding part determining a code book of a codeword length of a minimum accumulated result and encoding the quantized values in the sub-band based on the determined code book.

### CROSS-REFERENCE TO RELATED APPLICATIONS

This application is based upon and claims the benefit of priority of the prior Japanese Patent Application No. 2008-193957, filed on Jul. 28, 2008, the entire contents of which are incorporated herein by reference.

### FIELD

The embodiments discussed herein are directed to an audio coding apparatus, an audio coding method, and a computer-readable recording medium storing an audio coding program for Huffman-coding frequency spectrum data of an audio signal.

### BACKGROUND

Recently, as a method for coding an audio signal, there has been adopted a method for Huffman-coding frequency spectrum data of a quantized audio signal for highly efficient compression. Examples of the coding method include an MPEG2-AAC (Moving Picture Experts Group 2-Advanced Audio Coding) standard (for example, ISO/IEC 13818-7).

The audio coding apparatus using such a coding method obtains 1024 samples of frequency spectrum data by performing an MDCT (Modified Discrete Cosine Transform) process on a PCM (Pulse Code Modulation) signal obtained by quantizing an audio signal.

Further, the audio coding apparatus obtains an integer quantized value Q by performing a nonlinear quantization process on the 1024 samples of frequency spectrum data. The quantized value Q may be expressed by the following formula 1.

Q=|X|^{3/4}*2⁽3/16*(scale^{_{—}}^{factor[sb]-common}^{_{—}}^{scale)+MAGIC}^{_{—}}^{NUMBER)}*sign(X) Formula 1

“X” in the formula I denotes a quantized MDCT coefficient, “scale_factor” denotes a scale value for each sub-band, “common_scale” denotes a global scale value of the entire frequency band, “MAGIC_NUMBER” denotes a magic number (0.4054 for an AAC encoder), and “sign(X)” corresponds to code information (sign(X)=1 for X>0, sign(X)=−1 for X<0) of the quantized MDCT coefficient X.

Further, when the quantized values Q of the 1024 samples of frequency spectrum data are Huffman-coded, the audio coding apparatus divides the quantized values Q into a group of sub-bands of a frequency band. When the sampling frequency is 48 kHz, the audio coding apparatus may divide the quantized values Q of the 1024 samples of frequency spectrum data into a group of 49 sub-bands.

Then, the audio coding apparatus extracts a maximum absolute quantized value Q (MAX) of all the quantized values Q in the sub-band for each sub-band. The audio coding apparatus selects a code book corresponding to the extracted maximum absolute quantized value Q (MAX) from a plurality of code books. According to the AAC standard, eleven code books from #1 to #11 are available.

The audio coding apparatus selects the code books “#1” and “#2” for the quantized value Q (MAX)<2, the code books “#3” and “#4” for the quantized value Q (MAX)<3, the code books “#5” and “#6” for the quantized value Q (MAX)<5, the code books “#7” and “#8” for the quantized value Q (MAX)<8, the code books “#9” and “#10” for the quantized value Q (MAX)<13, and the code book “#11” for the quantized value Q (MAX)>13.

The code books store Huffman-coded codeword lengths and hexadecimal codewords of the Huffman-coded data for each index number.

Further, the audio coding apparatus provides an index value calculation expression for calculating an index value (index) according to the type of the selected code book.

Index value calculation expressions are used based on the selected code books as follows. The code books “#1” and “#2” correspond to the expression: index=27*Q[i]+9*Q[i+1]+3*Q[i+2]+Q[i+3]+40; the code books “#3” and “#4” correspond to the expression: index=27*Q[i]+9*|Q[i+1]|+3*|Q[i+2]|+|Q[i+3]|; the code books “#5” and “#6” correspond to the expression: index=9*Q[i]+9*Q[i+1]+40; the code books “#7” and “#8” correspond to the expression: index=8*|Q[i]|+|Q[i+1]|; and the code books “#9” and “#10” correspond to the expression: index=13*|Q[i]|+|Q[i+1]|. Note that “[i]” corresponds to a number serially assigned to the quantized values Q in the sub-band.

The audio coding apparatus selects an index value calculation expression based on the selected two kinds of code books, extracts the quantized values Q for a given number of samples (two or four) in the sub-band for each sub-band, and assigns the extracted quantized values Q to the index value calculation expression to calculate the index value. When the code books from “#1” to “#4” are selected, four quantized values Q are extracted; and when the code books from “#5” to “#11” are selected, two quantized values Q are extracted as the given number of samples.

When the index value is calculated, the audio coding apparatus reads the individual Huffman-coded codeword lengths corresponding to the index value of the two kinds of code books to be used, and stores the read codeword lengths of the individual code books.

Further, the audio coding apparatus extracts the next quantized values Q for a given number of samples in the sub-band, and assigns the extracted quantized values Q to the index value calculation expression to calculate the next index value.

Next, when the index value is calculated, the audio coding apparatus reads the individual codeword lengths corresponding to the index value of the two kinds of code books to be used, and stores the read codeword lengths of the individual code books.

When the audio coding apparatus completes reading all the codeword lengths of the individual code books related to all the quantized values Q in the sub-band for each sub-band, the audio coding apparatus obtains the accumulated results of the stored codeword lengths corresponding to the two kinds of code books in the sub-band.

Next, when the audio coding apparatus obtains the accumulated results of the individual codeword lengths corresponding to the two kinds of code books in the sub-band, the audio coding apparatus compares the accumulated results of the individual codeword lengths corresponding to the two kinds of code books, determines the code book related to the codeword length of a minimum accumulated result, and uses the determined code book as the optimal code book to code the quantized values Q in the sub-band

To sum up, the audio coding apparatus serially determines an optimal code book for each sub-band and uses the optimal code book to Huffman-code the quantized values in the sub-band for each sub-band (see Japanese Patent Laid-Open No. 2001-7707).

The object and advantages of the embodiment discussed herein will be realized and attained by means of elements and combinations particularly pointed out in the claims.

It is to be understood that both the foregoing general description and the following detailed and the following detailed description are exemplary and only are not restrictive exemplary explanatory are not restrictive of the invention, as claimed.

### SUMMARY

It is an aspect of the embodiments discussed herein to provide an audio encoding apparatus. The audio encoding apparatus includes: a sub-band division part dividing a quantized value, which is obtained by converting an audio signal into a frequency spectrum and nonlinearly quantizing the frequency spectrum, into sub-bands; an integrated codeword length table including a plurality of codeword length tables storing codeword lengths of individual code books defined by a given number of bits for each common index number obtained by integrating a given combination of code books of a plurality of code books managing Huffman-coded codeword lengths for each index number, and a plurality of codeword length tables storing codeword lengths of individual code books defined by a number of bits smaller than the given number of bits; a code book selection part selecting, from the plurality of code books, the given combination of code books corresponding to a maximum absolute quantized value of all the quantized values in the sub-band divided by the sub-band division part; a codeword length table selection part selecting a codeword length table from among a plurality of codeword length tables related to the given combination of code books selected by the code book selection part; an index value calculation part sequentially calculating an index value to be used by the code book selected by the code book selection part based on the extracted quantized value each time the quantized value in the sub-band divided by the sub-band division part is sequentially extracted for each given number of samples; a codeword length calculation part collectively obtaining codeword lengths for each code book from the codeword length table selected by the codeword length table selection part based on the index value sequentially calculated by the index value calculation part and accumulating the collectively obtained codeword lengths for each code book; and a coding part determining a code book of a codeword length of a minimum accumulated result of the accumulated results of the codeword lengths of the individual code books for each sub-band when the codeword length calculation part completes accumulating the codeword lengths of the individual code books related to all the quantized values in the sub-band, and encoding the quantized values in the sub-band based on the determined code book.

### BRIEF DESCRIPTION OF THE DRAWINGS

FIG. 1 is a block diagram illustrating an example of an internal schematic configuration of the audio coding apparatus according to the present embodiment;

FIG. 2 is an explanatory drawing schematically illustrating an example of a table content of a 32-bit width codeword length table;

FIG. 3 is an example of the explanatory drawings briefly illustrating a 32-bit width codeword length table of “#1” and “#2” obtained by integrating the codeword lengths of the code books “#1” and “#2”;

FIG. 4 is an example of the explanatory drawings briefly illustrating a 16-bit width codeword length table of “#1” and “#2”;

FIG. 5 is an example of an operation chart illustrating an internal processing operation of the audio coding apparatus related to an audio coding process according to the present embodiment;

FIG. 6 is an explanatory drawing related to a codeword length calculation process using the 32-bit width codeword length table according to the present embodiment;

FIG. 7 is an explanatory drawing related to an example of a minimum codeword length value determination process according to the present embodiment;

FIG. 8 is an example of the explanatory drawings related to a minimum codeword length value determination process according to the present embodiment; and

FIG. 9 is an example of the explanatory drawings related to the codeword length calculation process using the 16-bit width codeword length table according to the present embodiment.

### DETAILED DESCRIPTION OF THE EMBODIMENTS

A conventional audio coding apparatus includes two kinds of code books, which are selected for each sub-band, and an index value which is calculated based on the selected code books. Then, the individual codeword lengths corresponding to each index value are read from the two kinds of code books, and further, the accumulated results of the codeword lengths of these two kinds of code books are calculated. However, such a codeword length calculation process requires a complicated process and thus is not very efficient.

Further, according to the conventional audio coding apparatus, when the codeword lengths of the individual code books are calculated, a code book managing the codeword lengths defined by a given number of bits such as 16 bits indicating a high sound quality is used. For example, although the number of samples of the quantized values Q in a sub-band is small or the high quality sound is not required, the code book having the codeword lengths defined by the given number of bits indicating a high sound quality is used, thus resulting in a very high processing load.

An aspect of the embodiments disclosed herein is to provide an audio coding apparatus, an audio coding program, and an audio coding method which may improve the processing efficiency of the codeword length calculation process for calculating an accumulated result of the codeword lengths related to the two kinds of code books for each sub-band as well as reduce the processing load required for the codeword length calculation process depending on the condition and as a result, improve the processing speed of the entire optimal code book determination process.

Hereinafter, the embodiments according to the audio coding apparatus, the audio coding program, and the audio coding method using Huffman coding according to the present invention will be described in detail with reference to the accompanying drawings.

First, the outline of the embodiments is described by assuming that the coding process is a 32 bit process and the number of samples of the quantized values obtained by nonlinearly quantizing the frequency spectrum data of an audio signal is equal to or less than 32. The coding process includes integrating a given combination of two kinds of code books of the plurality of code books and uses a plurality of 32-bit width codeword length tables in which the codeword lengths of individual code books defined by 16 bits are stored for each common index number; and a plurality of 16-bit width codeword length tables in which the codeword lengths of individual code books defined by 8 bits are stored for each common index number.

According to the present embodiment, when the accumulated results of the two codeword lengths are calculated, the index value is calculated, the codeword lengths of individual code books corresponding to the index value are collectively obtained from the codeword length table, and the collectively obtained codeword lengths are accumulated for each code book. As a result, the present embodiment may improve the processing efficiency of the codeword length calculation process of calculating the accumulated results of the codeword lengths related to the two kinds of code books for each sub-band.

Further, according to the present embodiment, when the accumulated results of the two codeword lengths are calculated, these codeword length tables are made selectable, so that the present embodiment may reduce the processing load required for the codeword length calculation process depending on the condition using the 16-bit width codeword length tables storing the codeword lengths defined by 8 bits and as a result, improve the processing speed of the entire optimal code book determination process.

### First Embodiment

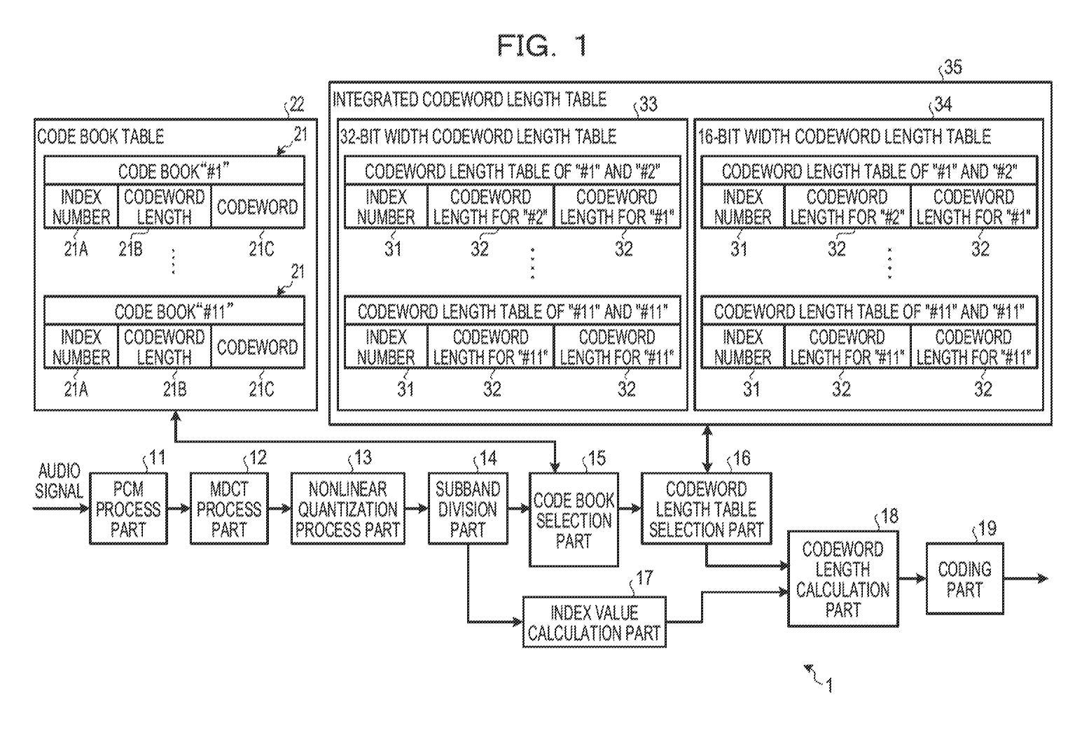

FIG. 1 is a block diagram illustrating an example of an internal schematic configuration of the audio coding apparatus according to the present embodiment.

The audio coding apparatus 1 illustrated in FIG. 1 includes a PCM process part 11, which obtains a PCM signal by quantizing an audio signal, and an MDCT process part 12, which obtains 1024 samples of frequency spectrum data by performing an MDCT process on the PCM signal obtained by the PCM process part 11.

Further, the audio coding apparatus 1 includes a nonlinear quantization process part 13, which obtains an integer quantized value Q by performing a nonlinear quantization process on the frequency spectrum data obtained by the MDCT process part 12, and a sub-band division part 14, which divides a quantized value obtained by the nonlinear quantization process part 13 into sub-bands.

If the sampling frequency is 48 kHz, the sub-band division part 14 divides a quantized value Q of the 1024 samples of frequency spectrum data into a group of 49 sub-bands.

Further, the audio coding apparatus 1 includes a code book table 22 which manages eleven code books 21 from “#1” to “#11” each of which manages Huffman-coded codeword lengths 21B and hexadecimal codewords 21C for each of the 81 index numbers 21A from 0 to 80.

Further, the audio coding apparatus 1 includes an integrated codeword length table 35 which integrates a given combination of code books 21 of the eleven code books 21 and includes a 32-bit width codeword length table 33 and a 16-bit width codeword length table 34, each of which stores codeword lengths 32 corresponding to the same combination of code books 21 for each of the 81 common index numbers 31 from 0 to 80.

Note that the given combinations of code books 21 are as follows:

the code books 21 “#1” and “#2” for the quantized value Q (MAX)<2,

the code books 21 “#3” and “#4” for the quantized value Q (MAX)<3,

the code books 21 “#5” and “#6” for the quantized value Q (MAX)<5,

the code books 21 “#7” and “#8” for the quantized value Q (MAX)<8, and

the code books 21 “#9” and “#10” for the quantized value Q (MAX)<13.

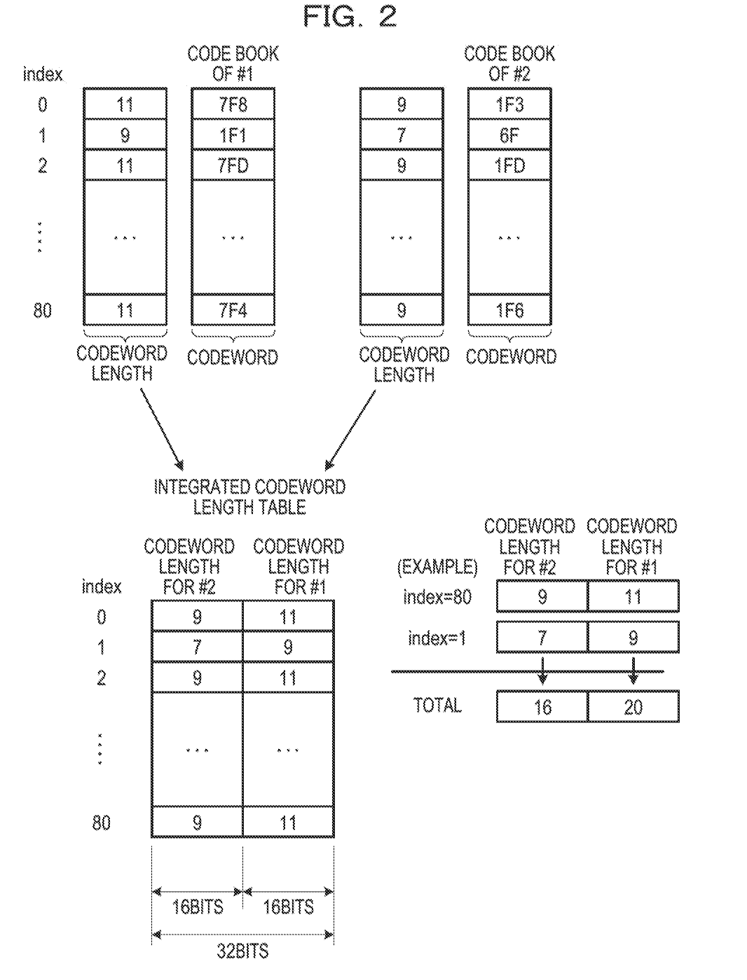

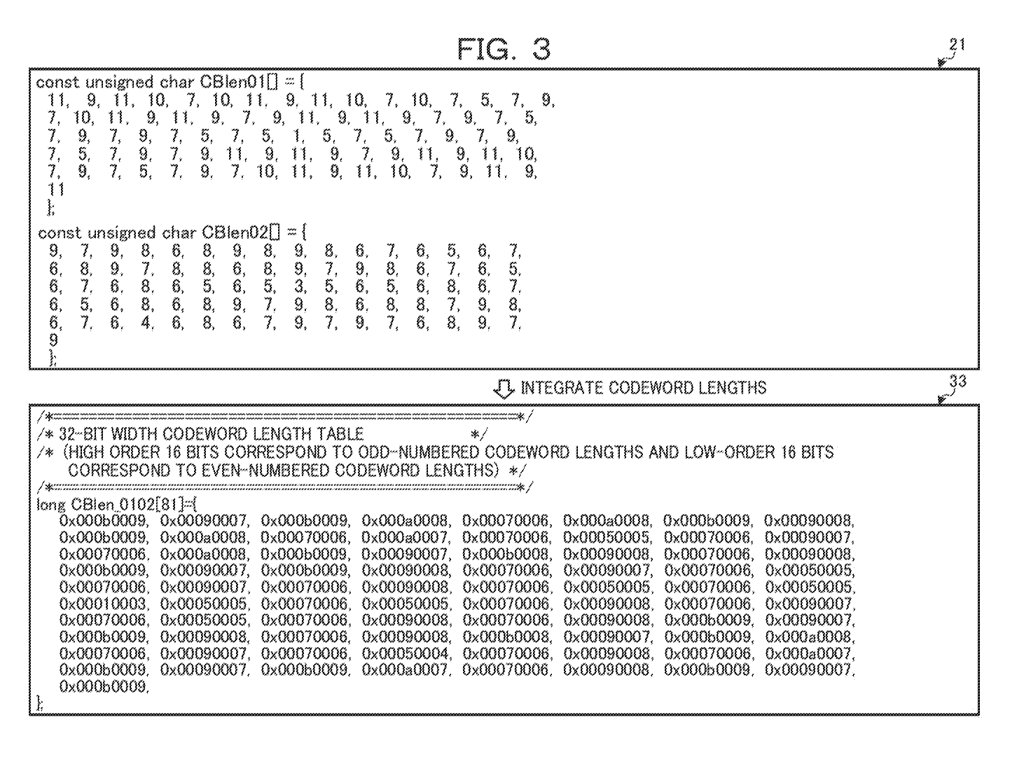

FIG. 2 is an example of explanatory drawings schematically illustrating the table contents of a 32-bit width codeword length table 33. FIG. 3 is an example of explanatory drawings briefly illustrating a 32-bit width codeword length table 33 “#1” and “#2” obtained by integrating the codeword lengths 21B of the code books 21 “#1” and “#2”.

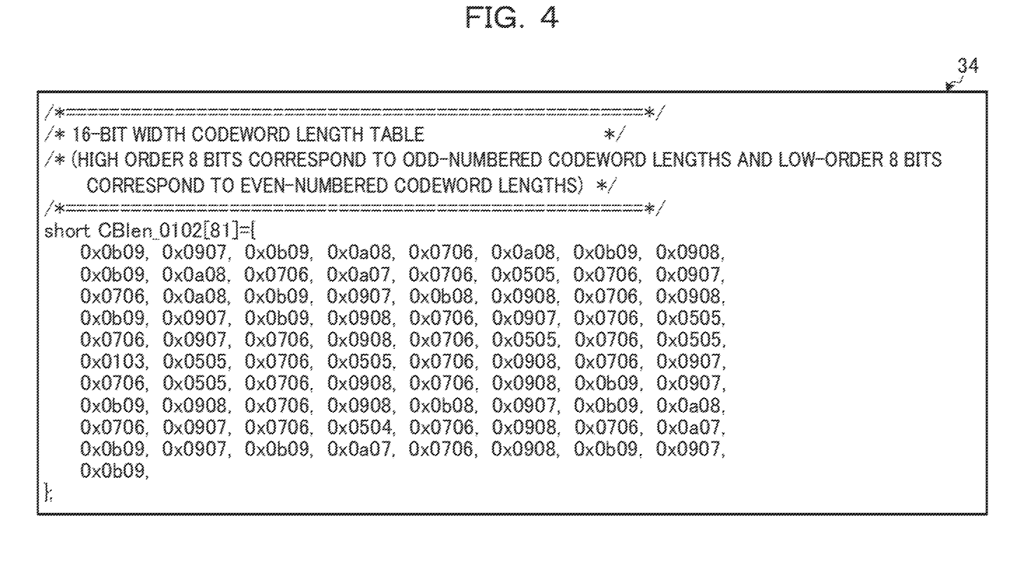

For example, the 32-bit width codeword length table 33 integrates the code books 21 “#1” and “#2”, and stores the 16 bits-defined codeword lengths 32 related to the code book 21 “#2” by the high order 16 bits and the 16 bits-defined codeword length 32 related to the code book 21 “#1” by the low order 16 bits for each of the common index numbers 31 from 0 to 80. For example, although not illustrated here, the 16-bit width codeword length table 34 integrates the code books 21 “#1” and “#2” and stores the 8 bits-defined codeword length 32 related to the code book 21 of “#2” by the high order 8 bits and the 8 bits-defined codeword lengths 32 related to the code book 21 “#1” by the low order 8 bits for each of the common index numbers 31 from 0 to 80. FIG. 4 is an example of the explanatory drawings briefly illustrating the 16-bit width codeword length table 34 “#1” and “#2”.

Further, the audio coding apparatus 1 illustrated in FIG. 1 includes a code book selection part 15 which selects a given combination of code books 21 corresponding to a maximum absolute quantized value Q(MAX) of the quantized values Q in the sub-bands divided by the sub-band division part 14 from the plurality of code books 21; and a codeword length table selection part 16 which selects a 32-bit width codeword length table 33 or a 16-bit width codeword length table 34 from the integrated codeword length table 35 including the code book 21 selected by the code book selection part 15.

The code book selection part 15 selects the given combination of code books 21 corresponding to the maximum absolute quantized values Q (MAX) of the quantized values Q in the sub-band from the code book table 22.

The code book selection part 15 selects:

the code books 21 “#1” and “#2” for the quantized value Q (MAX)<2,

the code books 21 “#3” and “#4” for the quantized value Q (MAX)<3,

the code books 21 “#5” and “#6” for the quantized value Q (MAX)<5,

the code books 21 “#7” and “#8” for the quantized value Q (MAX)<8, and

the code books 21 “#9” and “#10” for the quantized value Q (MAX)<13.

The codeword length table selection part 16 selects the 32-bit width codeword length table 33 or the 16-bit width codeword length table 34 including the given combination of code books 21 selected by the code book selection part 15.

Further, the audio coding apparatus 1 includes an index value calculation part 17 which sequentially extracts the quantized value in a sub-band divided by the sub-band division part 14 for the given number of samples and uses the sequentially extracted quantized value to calculate an index value to be used by the given combination of code books 21 selected by the code book selection part 15.

The index value calculation part 17 sequentially extracts the quantized values in the sub-band for the given number of samples such as two samples or four samples, and assigns the sequentially extracted quantized values to the index value calculation expression corresponding to the given combination of code books 21 selected by the code book selection part 15. Thereby, the index value calculation part 17 calculates a common index value corresponding to the given combination of code books 21. Note that for the code books 21 from “#1” to “#4”, quantized values Q are extracted for each of the four samples, and for the code books 21 from “#5” to “#11”, quantized values Q are extracted for each of the two samples.

Further, the audio coding apparatus 1 includes a codeword length calculation part 18 which uses the common index value calculated by the index value calculation part 17 to sequentially obtain codeword lengths 32 related to the given combination of code books 21 from the codeword length tables 33 and 34 in the integrated codeword length table 35 selected by the codeword length table selection part 16.

As illustrated in FIG. 2, the codeword length calculation part 18 collectively obtains the codeword lengths for the code books 21 of “#1” and “#2” calculated by the index value calculation part 17, for example, the codeword length “11” of the code book “#1” and the codeword length “9” of the code book “#2” corresponding to the common index number 31 “80”, from the 32-bit width codeword length table 33 and stores the codeword length 32 of the code book “#1” and the codeword length 32 of the code book “#2”.

Further, the codeword length calculation part 18 collectively obtains the codeword lengths for the code books 21 “#1” and “#2” calculated by the index value calculation part 17, for example, the codeword length “9” of the code book “#1” and the codeword length “7” of the code book “#2” corresponding to the common index number 31 “1”, and accumulates the codeword lengths to the stored codeword length 32 of the code book “#1” and codeword length 32 of the code book “#2”. As a result, the accumulated result of the codeword length 32 of the code book “#1” is “20”, and the accumulated result of the codeword length 32 of the code book “#2” is “16”.

In this manner, the codeword length calculation part 18 calculates the accumulated results of the codeword length 32 of code book “#1” and the codeword length 32 of code book “#2” of all the quantized values in the sub-band respectively.

Further, the audio coding apparatus 1 determines the code book 21 storing the codeword length 32 of the minimum accumulated result of the accumulated results of the codeword lengths 32 calculated by the codeword length calculation part 18 for each code book 21 corresponding to an individual sub-band. The audio coding apparatus 1 includes a coding part 19 which uses the determined code book 21 to code the quantized values Q in the sub-band.

As described above, the integrated codeword length table 35 includes not only the 32-bit width codeword length table 33 but also the 16-bit width codeword length table 34. Hereinafter, the 16-bit width codeword length table 34 will be described.

In general, the number of spectral samples in a sub-band is a maximum of 96 samples at a sampling rate of 48 kHz, and a maximum of 32 samples at a sampling rate of less than 48 kHz. In view of the above, when 32 spectral samples are assumed to be Huffman-coded, a maximum value of the accumulated result of the codeword length 32 is considered to be a case of the code books 21 from “#5” to “#11” using only two quantized values when an index value is calculated. Therefore, the maximum value of the accumulated result of the codeword length 32 calculated by Huffman-coding the 32 spectral samples in a sub-band is 15 bits*(32/2)=240. In other words, the value is an 8-bit width.

To sum up, when a sub-band stores 32 spectra per sub-band, a maximum value of one Huffman-coded codeword length does not exceed the 8-bit width. In other words, the 32-bit width codeword length table 33 is not required. Therefore, allowing for adding a codeword length when coded, the 16-bit width of the two kinds of code books 21 is enough for the sub-band. For this reason, the integrated codeword length table 35 includes the 32-bit width codeword length table 33 and the 16-bit width codeword length table 34 separately.

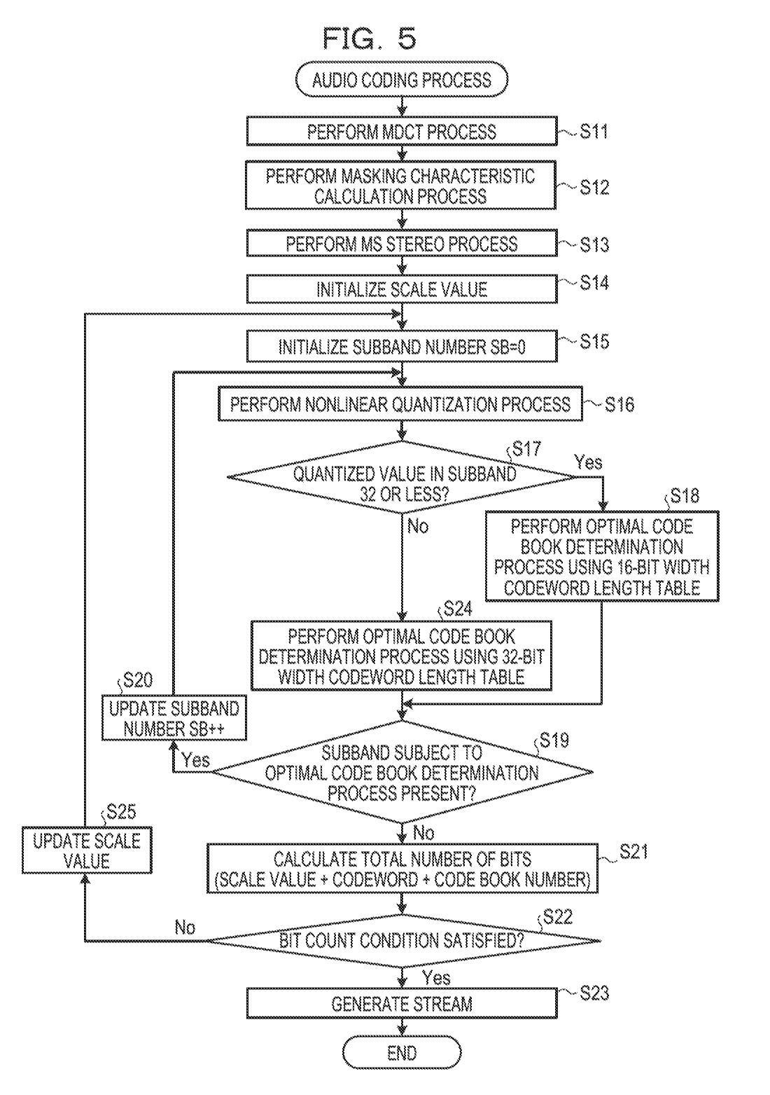

Hereinafter, the operation of the audio coding apparatus 1 according to the present embodiment will be described. FIG. 5 is an operation chart illustrating an internal processing operation of the audio coding apparatus 1 related to an audio coding process according to the present embodiment.

In FIG. 5, the MDCT process part 12 performs an MDCT process on a PCM signal obtained by quantizing an audio signal (at operation S11), and obtains 1024 samples of frequency spectrum data.

After the MDCT process at the operation S11, the audio coding apparatus 1 performs a masking characteristic calculation process on the 1024 samples of frequency spectrum data (at operation S12), and further performs an MS stereo process on the frequency spectrum data (at operation S13).

Further, the audio coding apparatus 1 initializes a scale value (at operation S14), and then initializes a sub-band number for identifying the sub-band to be used to perform an optimal code book determination process described later (at operation S15).

The nonlinear quantization process part 13 in the audio coding apparatus 1 initializes the sub-band number, and then performs a nonlinear quantization process on the frequency spectrum data (at operation S16) to obtain the quantized value Q.

When the audio coding apparatus 1 obtains the quantized values Q of the frequency spectrum data, the audio coding apparatus 1 determines whether the quantized value Q in the sub-band is equal to or less than 32 (at operation S17).

When the audio coding apparatus 1 performs sampling at a sampling rate of 48 kHz, the number of samples of frequency spectrum data in a sub-band is a maximum of 96. In contrast, when the audio coding apparatus 1 performs sampling at a sampling rate of less than 48 kHz, the number of samples of frequency spectrum data in a sub-band is a maximum of 32.

If the quantized value Q in the sub-band is equal to or less than 32 (at operation S17: Yes), the audio coding apparatus 1 performs an optimal code book determination process using the 16-bit width codeword length table 34 (at operation S18).

Note that the optimal code book determination process determines, as the optimal code book 21, the code book 21 storing the codeword length 32 having a smaller accumulated result of the accumulated results of the codeword length 32 for each code book 21 related to the quantized values Q in the sub-band for each sub-band, and stores the optimal code book 21 and the codeword length 32 of the optimal code book 21.

The audio coding apparatus 1 performs the optimal code book determination process for each sub-band, and then determines whether or not there is a sub-band subject to the optimal code book determination process (at operation S19).

If there is a sub-band subject to the optimal code book determination process (at operation S19: Yes), the audio coding apparatus 1 updates the sub-band number (at operation S20), and proceeds to the operation S16 to obtain the quantized value Q of the frequency spectrum data in the next sub-band.

If there is no sub-band subject to the optimal code book determination process (at operation S19: No), the audio coding apparatus 1 calculates the total number of bits to be used as scale values, codewords, and the code book numbers of all the sub-bands (at operation S21).

The audio coding apparatus 1 determines whether or not the total number of bits calculated at the operation S21 satisfies the bit count condition (at operation S22).

If the number of bits satisfies the bit count condition (at operation S22: Yes), the audio coding apparatus 1 generates a stream coded using the optimal code book 21 which determines the quantized values of frequency spectrum data in all the sub-bands for each sub-band (at operation S23), and terminates the process operation illustrated in FIG. 5.

If the quantized value Q in the sub-band is larger than 32 (at operation S17: No), which means a normal way, the audio coding apparatus 1 performs the optimal code book determination process using the 32-bit width codeword length table 33 (at operation S24).

If the number of bits does not satisfy the bit count condition (at operation S22: No), the audio coding apparatus 1 updates the scale value so as to reduce the quantized value Q of frequency spectrum data (at operation S25), and proceeds to the operation S15 to perform the process starting at the first sub-band of all the sub-bands again.

According to the audio coding process illustrated in FIG. 5, if the quantized value Q of the frequency spectrum data in the sub-band is larger than 32, the audio coding apparatus 1 performs the optimal code book determination process using the 32-bit width codeword length table 33 in a normal way. If the quantized value Q of the frequency spectrum data in the sub-band is not larger than 32, the audio coding apparatus 1 performs the optimal code book determination process using the 16-bit width codeword length table 34. As a result, this may reduce the processing load required for the codeword length calculation process depending on the condition using the 16-bit width codeword length table 34.

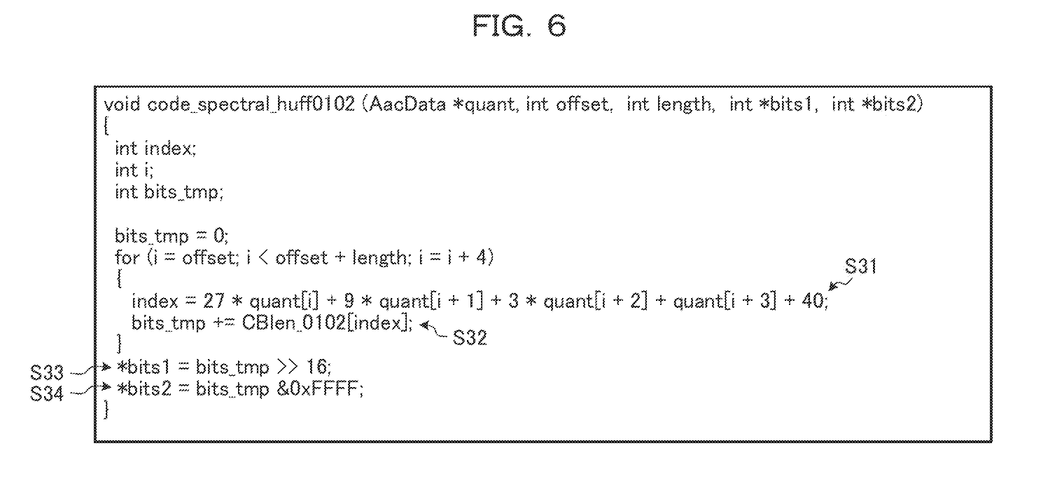

FIG. 6 is an example of an explanatory drawing related to a codeword length calculation process using the 32-bit width codeword length table 33 according to the present embodiment.

“quant” in FIG. 6 corresponds to a quantized value Q, “offset” corresponds to an offset position of the quantized value Q in all the frequency bands, “length” corresponds to the number of samples of frequency spectrum data found in the sub-band, “bits1” corresponds to a codeword length 32 Huffman-coded by the code book 21 “#1”, and “bits2” corresponds to a codeword length 32 Huffman-coded by the code book 21 “#2”.

The process in an operation S31 illustrated in FIG. 6 corresponds to the process of the index value calculation part 17 which calculates an index value by assigning, to the index value calculation expression, the quantized value Q in the sub-band Huffman-coded by the code books 21 “#1” and “#2” and stores the calculated index value in the variable index.

The process in an operation S32 corresponds to the process of the codeword length calculation part 18 which uses the index value calculated in the operation S31 as the common index value 31 and collectively obtains the codeword lengths 32 of the code books 21 “#1” and “#2” corresponding to the common index value 31 from the 32-bit width codeword length table 33. Then, the codeword length calculation part 18 accumulates the codeword lengths 32 to the 32-bit variable “bits_tmp” for each code book 21, and outputs the accumulated result of the codeword length 32 of the code book “#1” and the accumulated result of the codeword length 32 of the code book “#2”.

Note that the index value calculation part 17 and the codeword length calculation part 18 repeat the processes in the operation S31 and the operation S32 for length (the number of quantized values Q found in a sub-band) divided by 4 (the given loop count) and output an accumulated result of the codeword lengths 32 that used the code books 21 for each of the code books 21 “#1” and “#2” in the sub-band.

Further, the processes in operation S33 and operation S34 correspond to the process of the codeword length calculation part 18 which repeats the processes in the operation S31 and the operation S32 for a given number of loops, and then outputs an accumulated result of the codeword lengths 32 accumulated for each of the code books 21 “#1” and “#2”.

The codeword length calculation part 18 extracts the high order 16 bits of “bits_tmp,” and sets codeword length “bits1” that used the code book 21 “#1”. Further, the codeword length calculation part 18 extracts the low order 16 bits of “bits_tmp,” and sets codeword length “bits2” that used the code book 21 “#2”. As a result, the codeword length calculation part 18 collectively obtains the codeword lengths 32 corresponding to the quantized values Q in the sub-band that used the code books 21 “#1” and “#2” respectively, and terminates the codeword length calculation process as illustrated in FIG. 2.

For convenience of description, the use of the code books 21 “#1” and “#2” has been described but it will be apparent that the same may be applied to the use of the code books 21 of “#3” and “#4”, the use of the code books 21 of “#5” and “#6”, the use of the code books 21 of “#7” and “#8”, the use of the code books 21 of “#9” and “#10” and the use of the code book 21 of “#11”.

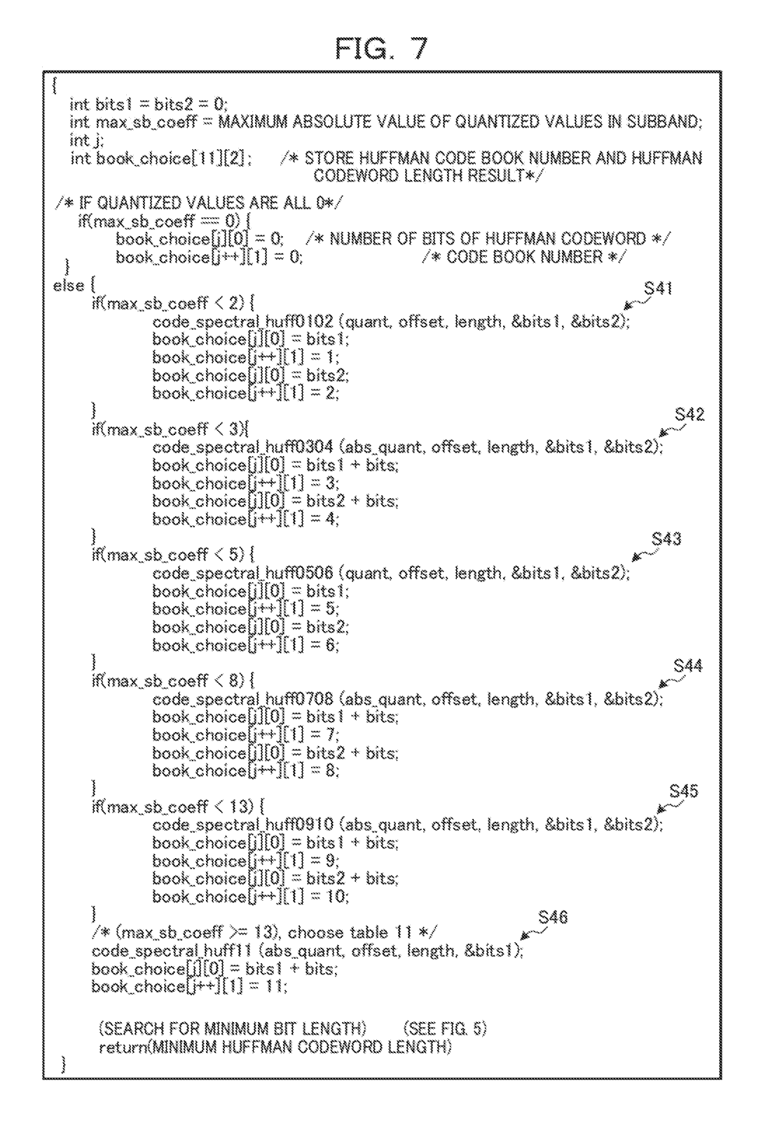

FIG. 7 is an example of an explanatory drawing related to a minimum codeword length value determination process according to the present embodiment.

“Bits1” and “bits2” illustrated in FIG. 7 correspond to the codeword lengths in the sub-band, “max_sb_coeff” corresponds to a maximum absolute value of the quantized values Q in the sub-band, “book_choice [11][2]” corresponds to the numbers of the code books 21 (#1 to #11) and the accumulated results (number of bits) of the codeword lengths 32, and “j” corresponds to the pointer of the “book_choice[ ][2].”

The processes in operation S41 to operation S46 illustrated in FIG. 7 correspond to the processes of the codeword length calculation part 18 which stores, in “book_choice[j][0],” the accumulated result of the codeword lengths 32 to be used by the individual code books 21 in the sub-band obtained by the codeword length calculation process illustrated in FIG. 6, as well as stores, in “book_choice[j][1],” the code book number of the code book 21 to be used. When the accumulated result of the codeword lengths 32 and the code book number are stored, “j” is incremented by one.

The operation S41 is a process of storing the accumulated result of the codeword lengths 32 and the code book number that used the code books 21 “#1” and “#2”.

The operation S42 is a process of storing the accumulated result of the codeword lengths 32 and the code book number that used the code books 21 “#3” and “#4”.

The operation S43 is a process of storing the accumulated result of the codeword lengths 32 and the code book number that used the code books 21 “#5” and “#6”.

The operation S44 is a process of storing the accumulated result of the codeword lengths 32 and the code book number that used the code books 21 “#7” and “#8”.

The operation S45 is a process of storing the accumulated result of the codeword lengths 32 and the code book number that used the code books 21 “#9” and “#10”.

The operation S46 is a process of storing the accumulated result of the codeword lengths 32 and the code book number that used the code book 21 “#11”.

As a result, the codeword length calculation part 18 stores the code book number of the code book 21 related to the quantized values Q in the sub-band and the accumulated result of the codeword lengths 32 that used the code book 21.

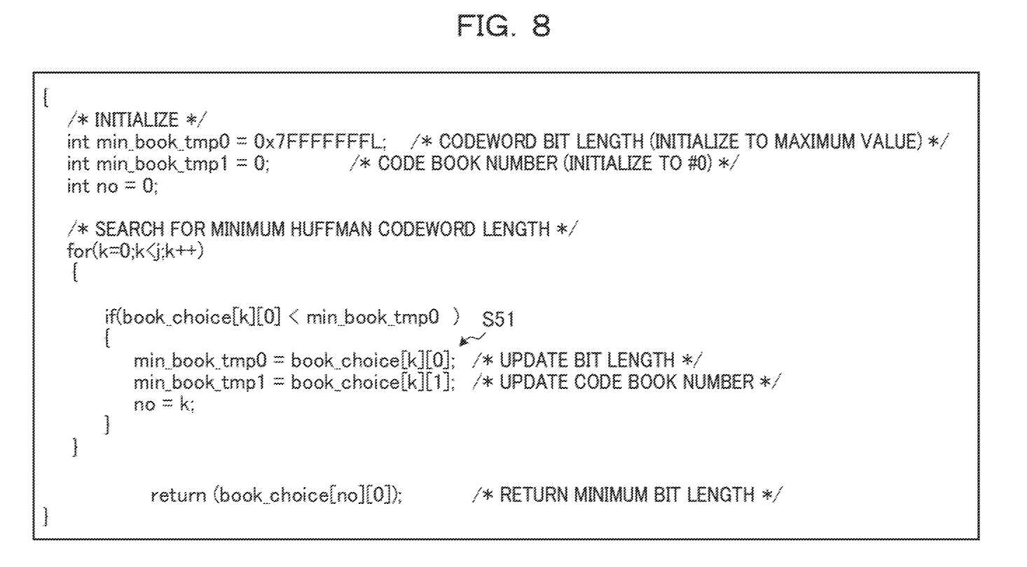

FIG. 8 is an explanatory drawing related to a minimum codeword length value determination process according to the present embodiment. Any one of the operations from S41 to S46 illustrated in FIG. 7 stores the code book number of the code book 21 related to the quantized value in the sub-band in “book_choice[j][++]” and stores the accumulated result of the codeword lengths 32 that used the code book 21 in “book_choice[j][0].” Then, the operation S51 illustrated in FIG. 8 selects the minimum codeword length 32 and the code book number of the codeword length 32 from the accumulated result of the codeword lengths 32 stored in “book_choice[j][0]” and “book_choice[j++][1]” and stores the accumulated result of the codeword lengths 32 and the code book number in “book_choice[k][0]” and “book_choice[k][1].”

As a result, the accumulated result of the codeword length 32 and the code book number stored in “book_choice[k][0]” and “book_choice[k][1]” are determined as the optimal code book 21 to be used in the sub-band.

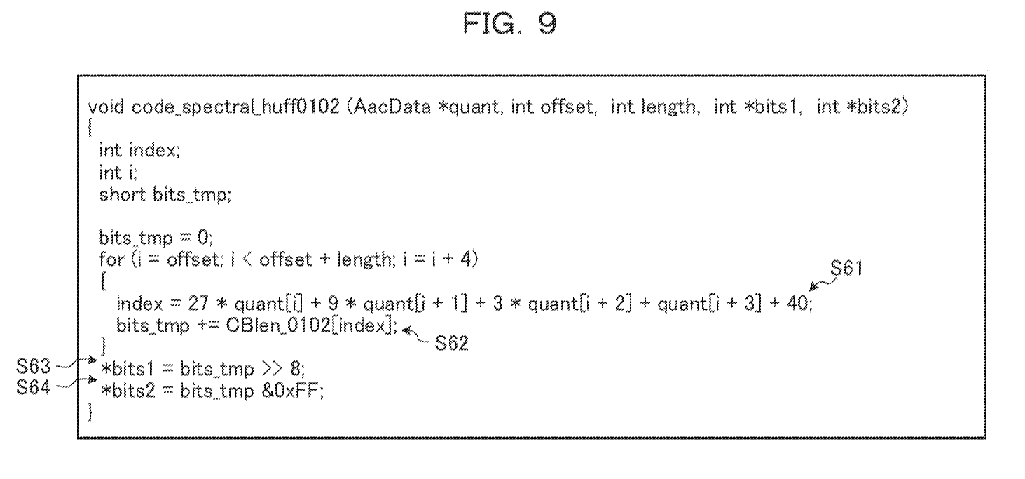

FIG. 9 is an example of the explanatory drawings related to the codeword length calculation process using the 16-bit width codeword length table 34 according to the present embodiment.

“quant” in FIG. 9 corresponds to a quantized value Q, “offset” corresponds to an offset position of the quantized value Q in all the frequency bands,
“length” corresponds to the number of samples of frequency spectrum data found in the sub-band, “bits1” corresponds to a codeword length 32 Huffman-coded by the code book 21 “#1”, and “bits2” corresponds to a codeword length 32 Huffman-coded by the code book 21 “#2”.

The process in operation S61 illustrated in FIG. 9 corresponds to the process of the index value calculation part 17 which calculates an index value by assigning, to the index value calculation expression, the quantized value Q in the sub-band Huffman-coded by the code books 21 “#1” and “#2” and stores the calculated index value in the variable index.

The process in operation S62 corresponds to the process of the codeword length calculation part 18 which uses the index value calculated in the operation S61 as the common index value and collectively obtains the codeword lengths of the code books “#1” and “#2” corresponding to the common index value from the 16-bit width codeword length table 34, then, adds the codeword lengths to the 16-bit variable bits_tmp and accumulates the codeword length 32 of the code book “#1” and the codeword length 32 of the code book “#2” at the same time.

Note that the index value calculation part 17 and the codeword length calculation part 18 repeat the processes in operation S61 and operation S62 for “length” (the number of quantized values found in a sub-band) divided by 4 (the given loop count) and calculates the accumulated result of the codeword lengths 32 that used the code books 21 for each of the code books 21 “#1” and “#2” in the sub-band.

Further, the processes in the operation S63 and the operation S64 correspond to the processes of the codeword length calculation part 18 which repeats the processes in the operation S61 and the operation S62 for a given number of loops, and then outputs the accumulated result of the codeword lengths accumulated for each of the code books 21 “#1” and “#2”.

The codeword length calculation part 18 extracts the high order 8 bits of “bits_tmp”, and sets codeword length “bits1” that used the code book 21 “#1”. Further, the codeword length calculation part 18 extracts the low order 8 bits of “bits_tmp”, and sets codeword length “bits2” that used the code book 21 “#2”. As a result, the codeword length calculation part 18 collectively obtains the codeword lengths 32 corresponding to the quantized values Q in the sub-band that used the code books 21 “#1” and “#2” respectively, and terminates the codeword length calculation process as illustrated in FIG. 9.

For convenience of description, the use of the code books 21 “#1” and “#2” has been described but it will be apparent that the same may be applied to the use of the code books 21 “#3” and “#4”, the use of the code books 21 “#5” and “#6”, the use of the code books 21 “#7” and “#8”, the use of the code books 21 “#9” and “#10,” and the use of the code book 21 “#11”.

According to the present embodiment, when the optimal code book determination process is performed, the index value is calculated each time the quantized values Q in the sub-band are sequentially extracted for each of the given number of samples according to the code book 21. The codeword lengths 32 of the two kinds of code books 21 are collectively obtained from the 32-bit width codeword length table 33 or the 16-bit width codeword length table 34 depending on the index value, and the collectively obtained codeword lengths 32 of the two kinds of code books 21 are accumulated until extraction of all the quantized values Q in the sub-band is completed. Therefore, in comparison with the conventional technique, the present embodiment may improve the processing efficiency of the codeword length calculation process of calculating the accumulated result of the codeword lengths 32 related to the two kinds of code books 21 for each sub-band.

Further, according to the present embodiment, when the optimal code book determination process is performed, if the quantized value Q in the sub-band is smaller than 32, the index value is calculated each time the quantized values in the sub-band are sequentially extracted for each of the given number of samples according to the code book 21, the codeword lengths 32 of the two kinds of code books 21 are collectively obtained from the 16-bit width codeword length table 34 depending on the index value, and the collectively obtained codeword lengths 32 of the two kinds of code books 21 are accumulated until extraction of all the quantized values Q in the sub-band is completed. Therefore, in comparison to using the 32-bit width codeword length table 33, the present embodiment may greatly reduce the processing load required for determining the optimal code book 21 of the sub-band and as a result, the present embodiment may achieve high-speed processing. The present embodiment may further reduce the power consumption required for table access.

The audio coding apparatus 1 may be installed in a device such as an audio reproducing device recording and reproducing audio or the like, a video reproducing device recording and reproducing video including audio, and a cell phone having a function of recording and reproducing audio.

Further, according to the present embodiment, after the index value is calculated, the codeword lengths of the two kinds of code books 21 may be accumulated by performing only one access to the 32-bit width codeword length table 33 or the 16-bit width codeword length table 34, thereby providing about 50% increase in efficiency of the optimal code book determination process of determining the optimal code book 21.

Further, the present embodiment may provide about 3% reduction in processing load of the entire coding process. If a part such as the MDCT process part 12 is implemented by hardware and the remaining parts are implemented by software, the present embodiment may provide about 30% reduction in processing load of the processor.

It should be noted that according to the present embodiment, the 32-bit width codeword length table 33 or the 16-bit width codeword length table 34 of the two kinds of code books 21 is selected based on the number of samples of quantized values Q in the sub-band, but the 32-bit width codeword length table 33 or the 16-bit width codeword length table 34 may be selected based on a given operation by the user side, for example, a switching operation on the operation part, thereby reducing the power consumption required for table access.

Further, according to the present embodiment, the frequency bandwidth of an audio signal is monitored, and if the frequency bandwidth is narrower than a given frequency bandwidth, the 16-bit width codeword length table 34 may be automatically selected, thereby reducing the power consumption required for table access.

Further, according to the present embodiment, the integrated codeword length table 35 includes not only the 32-bit width codeword length table 33 but also the 16-bit width codeword length table 34 separately, but the integrated codeword length table 35 may include only the 32-bit width codeword length table 33, and when the coding process starts, the 16-bit width codeword length table 34 may be generated from the 32-bit width codeword length table 33. In this case, the integrated codeword length table 35 needs to store only the 32-bit width codeword length table 33, thereby reducing the internal table capacity of the integrated codeword length table 35 by that amount.

Hereinbefore, the embodiments of the present invention have been described, but the scope of the technical concept of the present invention is not limited to the above embodiments, but it will be apparent that various modified embodiments may be implemented without departing from the scope of the technical concept disclosed in the claims. Further, the advantages disclosed in the present embodiments are not limited to this.

Further, it will be apparent that of the various processes described in the present embodiments, all or part of the processes described as performed automatically may be performed manually. Conversely, it will be apparent that all or part of the processes described as performed manually may be performed automatically. Further, it will be apparent that the information including the processing procedures, the control procedures, the exemplary names, various kinds of data, and parameters described in the present embodiments may be changed as needed unless otherwise noted.

Further, it will be apparent that the individual components of the individual apparatus in the drawings are functionally schematically illustrated, thus are not necessarily configured physically as illustrated, and the exemplary embodiments of the individual apparatus are not limited to the illustrated ones.

Further, it will be apparent that all or part of the various processing functions performed on the individual apparatus may be implemented on a micro computer such as a CPU (Central Processing Unit), an MPU (Micro Processing Unit), or an MCU (Micro Controller Unit); or a program which performs analysis and execution on the micro computer such as a CPU, an MPU, or an MCU; or hardware using wired logic.

Further, according to an aspect of the embodiments, any combinations of the described features, functions and/or operations may be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. An audio coding apparatus, comprising:
a sub-band division part dividing a quantized value, which is obtained by converting an audio signal into a frequency spectrum and nonlinearly quantizing the frequency spectrum, into sub-bands;
an integrated codeword length table including;
a plurality of codeword length tables storing codeword lengths of individual code books defined by a given number of bits for each common index number obtained by integrating a given combination of code books of a plurality of code books managing Huffman-coded codeword lengths for each index number, and
a plurality of codeword length tables storing codeword lengths of individual code books defined by a number of bits smaller than the given number of bits;
a code book selection part selecting, from the plurality of code books, the given combination of code books corresponding to a maximum absolute quantized value of all the quantized values in the sub-band divided by the sub-band division part;
a codeword length table selection part selecting a codeword length table from among a plurality of codeword length tables related to the given combination of code books selected by the code book selection part;
an index value calculation part sequentially calculating an index value to be used by the code book selected by the code book selection part based on the extracted quantized value each time the quantized value in the sub-band divided by the sub-band division part is sequentially extracted for each given number of samples;
a codeword length calculation part collectively obtaining codeword lengths for each code book from the codeword length table selected by the codeword length table selection part based on the index value sequentially calculated by the index value calculation part and accumulating the collectively obtained codeword lengths for each code book; and
a coding part determining a code book of a codeword length of a minimum accumulated result of the accumulated results of the codeword lengths of the individual code books for each sub-band when the codeword length calculation part completes accumulating the codeword lengths of the individual code books related to all the quantized values in the sub-band, and encoding the quantized values in the sub-band based on the determined code book.

2. The audio coding apparatus according to claim 1, wherein
the codeword length table selection part selects a codeword length table from among a plurality of codeword length tables related to the given combination of code books selected by the code book selection part based on the number of samples of quantized values in the sub-band.

3. The audio coding apparatus according to claim 1, wherein
the codeword length table selection part selects a codeword length table according to a given operation from among a plurality of codeword length tables related to the given combination of code books selected by the code book selection part.

4. The audio coding apparatus according to claim 1, wherein
the plurality of codeword length tables includes
a 32-bit width codeword length table storing codeword lengths defined by 16 bits related to a first code book with a high order 16-bit width as well as storing codeword lengths defined by 16 bits related to a second code book with a low order 16-bit width, and
a 16-bit width codeword length table storing codeword lengths defined by 8 bits related to a first code book with a high order 8-bit width as well as storing codeword lengths defined by 8 bits related to a second code book with a low order 8-bit width.

5. The audio coding apparatus according to claim 2, wherein
the plurality of codeword length tables includes
a 32-bit width codeword length table storing codeword lengths defined by 16 bits related to a first code book with a high order 16-bit width as well as storing codeword lengths defined by 16 bits related to a second code book with a low order 16-bit width, and
a 16-bit width codeword length table storing codeword lengths defined by 8 bits related to a first code book with a high order 8-bit width as well as storing codeword lengths defined by 8 bits related to a second code book with a low order 8-bit width.

6. The audio coding apparatus according to claim 3, wherein
the plurality of codeword length tables includes
a 32-bit width codeword length table storing codeword lengths defined by 16 bits related to a first code book with a high order 16-bit width as well as storing codeword lengths defined by 16 bits related to a second code book with a low order 16-bit width, and
a 16-bit width codeword length table storing codeword lengths defined by 8 bits related to a first code book with a high order 8-bit width as well as storing codeword lengths defined by 8 bits related to a second code book with a low order 8-bit width.

7. The audio coding apparatus according to claim 4, wherein
the codeword length table selection part automatically selects the 16-bit width codeword length table related to the given combination of code books selected by the code book selection part if the number of samples of quantized values in the sub-band is not larger than a given number of samples.

8. The audio coding apparatus according to claim 5, wherein
the codeword length table selection part automatically selects the 16-bit width codeword length table related to the given combination of code books selected by the code book selection part if the number of samples of quantized values in the sub-band is not larger than a given number of samples.

9. The audio coding apparatus according to claim 4, wherein
the codeword length table selection part automatically selects the 16-bit width codeword length table related to the given combination of code books selected by the code book selection part if a frequency bandwidth of the audio signal is narrower than a given frequency band.

10. The audio coding apparatus according to claim 5, wherein
the codeword length table selection part automatically selects the 16-bit width codeword length table related to the given combination of code books selected by the code book selection part if a frequency bandwidth of the audio signal is narrower than a given frequency band.

11. The audio coding apparatus according to claim 1, wherein
the given combination is equivalent to any combination of Huffman code books to be used in the MPEG-AAL standard including a combination of Huffman code book “1” and Huffman code book “2”, a combination of Huffman code book “3” and Huffman code book “4”, a combination of Huffman code book “5” and Huffman code book “6”, a combination of Huffman code book “7” and Huffman code book “8”, and a combination of Huffman code book “9” and Huffman code book “10”.

12. The audio coding apparatus according to claim 2, wherein
the given combination is equivalent to any combination of Huffman code books to be used in the MPEG-AAL standard including a combination of Huffman code book “1” and Huffman code book “2”, a combination of Huffman code book “3” and Huffman code book “4”, a combination of Huffman code book “5” and Huffman code book “6”, a combination of Huffman code book “7” and Huffman code book “8”, and a combination of Huffman code book “9” and Huffman code book “10”.

13. The audio coding apparatus according to claim 3, wherein
the given combination is equivalent to any combination of Huffman code books to be used in the MPEG-AAL standard including a combination of Huffman code book “1” and Huffman code book “2”, a combination of Huffman code book “3” and Huffman code book “4”, a combination of Huffman code book “5” and Huffman code book “6”, a combination of Huffman code book “7” and Huffman code book “8”, and a combination of Huffman code book “9” and Huffman code book “10”.

14. The audio coding apparatus according to claim 4, wherein
the given combination is equivalent to any combination of Huffman code books to be used in the MPEG-AAL standard including a combination of Huffman code book “1” and Huffman code book “2”, a combination of Huffman code book “3” and Huffman code book “4”, a combination of Huffman code book “5” and Huffman code book “6”, a combination of Huffman code book “7” and Huffman code book “8”, and a combination of Huffman code book “9” and Huffman code book “10”.

15. The audio coding apparatus according to claim 1, wherein the audio coding apparatus is installed in a recording/reproducing device recording and reproducing video and audio.

16. The audio coding apparatus according to claim 1, wherein the audio coding apparatus is installed in an audio recording/reproducing device recording and reproducing audio.

17. The audio coding apparatus according to claim 1, wherein the audio coding apparatus is installed in a cell phone having an audio recording/reproducing device recording and reproducing audio.

18. A computer-readable recording medium storing a computer program for causing a computer to function as an audio coding apparatus, the computer program causing the computer to execute:
dividing a quantized value, which is obtained by converting an audio signal into a frequency spectrum and nonlinearly quantizing the frequency spectrum, into sub-bands;
preparing an integrated codeword length table including a plurality of codeword length tables storing codeword lengths of individual code books defined by a given number of bits for each common index number obtained by integrating a given combination of code books of a plurality of code books managing Huffman-coded codeword lengths for each index number, and a plurality of integrated codeword length tables storing codeword lengths of individual code books defined by a number of bits smaller than the given number of bits;
selecting, from the plurality of code books, the given combination of code books corresponding to a maximum absolute quantized value of all the quantized values in the sub-band divided by the sub-band division;
selecting a codeword length table, which is related to the given combination of code books selected by the code book selecting, from among a plurality of codeword length tables;
sequentially calculating an index value to be used by the code book selected by the code book selecting based on the extracted quantized value each time the quantized value in the sub-band divided by the sub-band division is sequentially extracted for each given number of samples;
collectively obtaining codeword lengths for each code book from the codeword length table selected by the codeword length table selecting based on the index value sequentially calculated by the index value calculating, and accumulating the collectively obtained codeword lengths for each code book; and
determining a code book of a codeword length of a minimum accumulated result of the accumulated results of the codeword lengths of the individual code books for each sub-band when the codeword length calculating completes accumulating the codeword lengths of the individual code books related to all the quantized values in the sub-band, and encoding the quantized values in the sub-band based on the determined code book.

19. An audio coding method for causing a computer to function as an audio coding apparatus, the audio coding method causing the computer to execute:
dividing a quantized value, which is obtained by converting an audio signal into a frequency spectrum and nonlinearly quantizing the frequency spectrum, into sub-bands;
preparing an integrated codeword length table including:
a plurality of codeword length tables storing codeword lengths of individual code books defined by a given number of bits for each common index number obtained by integrating a given combination of code books of a plurality of code books managing Huffman-coded codeword lengths for each index number, and
a plurality of integrated codeword length tables storing codeword lengths of individual code books defined by a number of bits smaller than the given number of bits;
selecting, from the plurality of code books, the given combination of code books corresponding to a maximum absolute quantized value of all the quantized values in the sub-band divided by the sub-band division;
selecting a codeword length table from among a plurality of codeword length tables related to the given combination of code books selected by the code book selecting;
sequentially calculating an index value to be used by the code book selected by the code book selecting based on the extracted quantized value each time the quantized value in the sub-band divided by the sub-band division is sequentially extracted for each given number of samples;
collectively obtaining codeword lengths for each code book from the codeword length table selected by the codeword length table selecting based on the index value sequentially calculated by the index value calculating, and accumulating the collectively obtained codeword lengths for each code book; and
determining a code book of a codeword length of a minimum accumulated result of the accumulated results of the codeword lengths of the individual code books for each sub-band when the codeword length calculating completes accumulating the codeword lengths of the individual code books related to all the quantized values in the sub-band, and encoding the quantized values in the sub-band based on the determined code book.

20. An audio coding apparatus, comprising:
a sub-band division part dividing a quantized value, which is obtained by converting an audio signal into a frequency spectrum and nonlinearly quantizing the frequency spectrum, into sub-bands;
an integrated codeword length table including a plurality of codeword length tables storing codeword lengths of individual code books defined by a given number of bits for each common index number obtained by integrating a given combination of code books of a plurality of code books managing Huffman-coded codeword lengths for each index number;
a code book selection part selecting, from the plurality of code books, the given combination of code books corresponding to a maximum absolute quantized value of all the quantized values in the sub-band divided by the sub-band division part;
a codeword length table selection part selecting a codeword length table, which is related to the given combination of code books selected by the code book selection part, from the integrated codeword length tables, and generating a codeword length table storing codeword lengths of individual code books defined by a number of bits smaller than the given number of bits based on the codeword lengths of individual code books defined by the given number of bits of the selected codeword length table, and enabling to select the generated codeword length table or the codeword length table defined by the given number of bits;
an index value calculation part sequentially calculating an index value to be used by the code book selected by the code book selection part based on the extracted quantized value each time the quantized value in the sub-band divided by the sub-band division part is sequentially extracted for each given number of samples;
a codeword length calculation part collectively obtaining codeword lengths for each code book from the codeword length table selected by the codeword length table selection part based on the index value sequentially calculated by the index value calculation part, and accumulating the collectively obtained codeword lengths for each code book; and
a coding part determining a code book of a codeword length of a minimum accumulated result of the accumulated results of the codeword lengths of the individual code books for each sub-band when the codeword length calculation part completes accumulating the codeword lengths of the individual code books related to all the quantized values in the sub-band, and encoding the quantized values in the sub-band based on the determined code book.
